(19) United States
(12) Patent Application Publication
(10) Pub. No.: US 2016/0162149 A1
(43) Pub. Date: Jun. 9, 2016

(54) MOBILE ELECTRONIC DEVICE, METHOD FOR DISPLAYING USER INTERFACE, AND RECORDING MEDIUM THEREOF

(71) Applicant: HTC Corporation, Taoyuan County (TW)

(72) Inventor: Hsin-Hao Lee, Taoyuan County (TW)

(21) Appl. No.: 14/561,217

(22) Filed: Dec. 5, 2014

(51) Int. Cl. G06F 3/0488; G06F 3/0481; G06F 3/041

(52) U.S. Cl. CPC G06F 3/0488; G06F 3/0412; G06F 3/0416; G06F 3/04817

(57) ABSTRACT

A mobile electronic device including a motion sensor, a processor, and a touch display is provided. The motion sensor detects motions of the mobile electronic device and generates a detection value accordingly. When the mobile electronic device is in work mode, the processor determines whether the detection value is within a first detection value range or a second detection value range. The touch display displays one of three user interfaces based on the determination described above. The first user interface has a plurality of application program icons displayed along a first side of the touch display. The second user interface has the plurality of application program icons displayed along a second side of the touch display. The third user interface has the plurality of application program icons displayed evenly between the first side of the touch display and the second side of the touch display.

### BACKGROUND OF THE INVENTION

1. Field of the Invention

This invention relates to a user interface (UI) for mobile electronic devices. More particularly, this invention relates to a mobile electronic device, a method for displaying user interface, and a recording medium thereof.

2. Description of Related Art

Due to flourish of mobile electronic devices and communications networks, mobile electronic devices have become the platform with the easiest access to network information. The ability to have information readily available and being online all the time make these devices essential everyday items for modern life, even replacing personal computers as the new internet connection platform.

At the same time, with complex and highly integrated application programs, and online information ever more abundant, the resolution and size of mobile electronic device displays grow rapidly. Palm-sized mobile electronic devices (for example, devices with 3.7-inch to 4-inch displays) are gradually being replaced by larger devices (for example devices with displays larger than 5 inches). But as the displays become bigger, mobile electronic devices also become more difficult to operate with just one hand.

Apart from complex uses such as web-browsing, just to unlock these electronic mobile devices, successfully locate the desired application, and successfully execute the application can be a hassle to the users. Furthermore, when under certain circumstances, for example when the user carries an item with one hand, or when the user uses one hand to hold on to the handle on a bus, and can only use one hand to operate a larger size mobile electronic device, one hand operation is even more difficult for the user.

### SUMMARY OF THE INVENTION

This invention provides a mobile electronic device, a method for displaying user interface, and a computer readable recording medium thereof to make the user interface of large size mobile electronic devices more convenient.

The mobile electronic device of this invention can operate in sleep mode or in work mode, and includes a motion sensor, a processor, and a touch display. The motion sensor detects motions of the mobile electronic device and generates a detection value. The processor is coupled to the motion sensor. When the mobile electronic device is in work mode, the processor determines if the detection value is within a first detection value range or a second detection value range. The touch control panel is coupled to the processor. When the processor determines the detection value is within the first detection value range, a first user interface is displayed. When the processor determines the detection value is within the second detection value range, a second user interface is displayed. When the processor determines the detection value is not within the first detection value range or the second detection value range, a third user interface is displayed. The first user interface has a plurality of application program icons displayed along a first side of the touch display. The second user interface has the plurality of application program icons displayed along a second side of the touch display. The third user interface has the plurality of application program icons displayed evenly between the first side of the touch display and the second side of the touch display.

The user interface display method of this invention can be used in a mobile electronic device. The mobile electronic device can operate in sleep mode or work mode and includes a touch display. The above method includes the following steps: detect motions of the mobile electronic device and generate a detection value based on the motion; determine if the detection value is within a first detection value range or a second detection range. When the detection value is determined by the processor to be within the first detection value range, a first user interface is displayed. The first user interface has a plurality of application program icons displayed along a first side of the touch display. When the detection value is determined by the processor to be within the second detection value range, a second user interface is displayed. The second user interface has a plurality of application program icons displayed along a second side of the touch display. When the detection value is determined by the processor to be not within the first detection value range or the second detection value range, a third user interface is displayed. The third user interface has a plurality of application program icons displayed evenly between the first side of the touch display and the second side of the touch display.

The computer-readable recording medium of this invention stores a computer program. When a mobile electronic device loads and executes the computer program, the mobile electronic device performs the user interface display method described above.

As described above, the user interface of mobile electronic device is adjusted according to various uses such as one hand operation, making user interfaces of large size mobile electronic devices more convenient to use.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a mobile electronic device of an embodiment.

FIG. 2 is a flowchart of a user interface display method of an embodiment.

FIG. 3 is a diagram of a default user interface of an embodiment.

FIGS. 4A to 5B are diagrams of methods of determining one hand operation according to multiple embodiments of this invention.

FIG. 6 is a diagram of a display area of a user interface display method of an embodiment.

FIGS. 7 to 8B are diagrams of methods of determining one hand operation according to multiple embodiments of this invention.

FIGS. 9A to 9B are diagrams of a control column of a user interface of an embodiment.

FIGS. 10A to 11B are diagrams of programs columns of user interfaces according to multiple embodiments of this invention.

FIGS. 12 to 13B are diagrams showing search functions of user interfaces according to multiple embodiments of this invention.

### BRIEF DESCRIPTION OF THE DRAWINGS

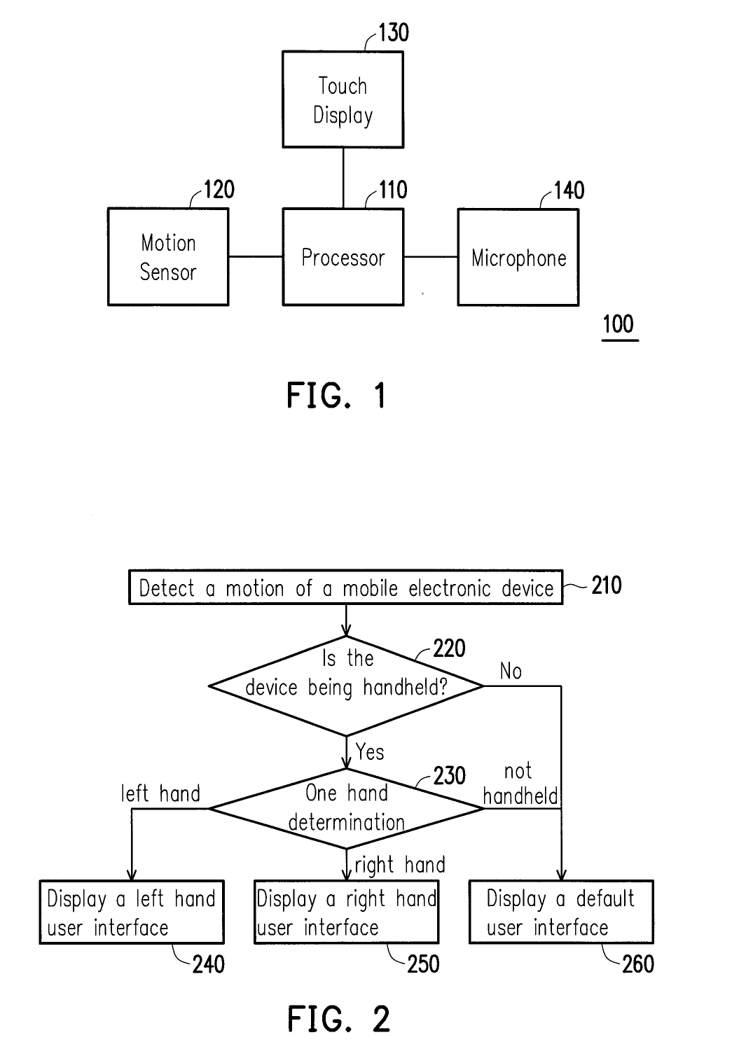

FIG. 1 is a diagram of a mobile electronic device 100 of an embodiment. The mobile electronic device 100 may be a smartphone, a personal digital assistant (PDA), a tablet, or other electronic device operable by just one hand. The mobile electronic device 100 includes a processor 110, a motion sensor 120, a touch display 130, and a microphone 140. The motion sensor 120 includes at least an accelerometer, a gyroscope, and electronic compass.

The mobile electronic device 100 can operate in sleep mode or work mode. The mobile electronic device 100 enters work mode when turned on. Then, if there is no user operation for a period of time, the mobile electronic device 100 enters sleep mode automatically. The user can also directly command the mobile electronic device 100 to enter sleep mode, for example by pushing the power button. In sleep mode, the user can engage in default operation on the touch display 130, or input invoice through the microphone 140, or push the power button to wake up the mobile electronic device 100 and cause it to return to work mode. The touch display 130 displays user interface when in work mode. The user interface is not displayed in sleep mode. The processor 110 determines whether the mobile electronic device 100 is in work mode or sleep mode, and according to the mode it is in, controls the touch display 130 to display or not display the user interface.

FIG. 2 is a flowchart of a user interface display method of an embodiment. This method may be executed when a mobile electronic device 100 first enters into work mode, or when a mobile electronic device 100 enters work mode from sleep mode, or when a mobile electronic device 100 is already in work mode.

The flowchart of FIG. 2 is explained below: A motion sensor 120 detects motions of the mobile electronic device 100 (step 210) and generates a detection value. A processor 110 determines if the mobile electronic device 100 is being handheld (step 220). The motion sensor 120 detects the swing or vibration of from the user's hand. If the motion sensor 120 detects above described swing or vibration, the processor 110 can determine that the mobile electronic device 100 is being handheld; otherwise, the processor 110 can determine that the mobile electronic device 100 is not being handheld. When the mobile electronic device 100 is being handheld, the processor 110 proceeds to determination of one hand operation (step 230). When the mobile electronic device 100 is not being handheld, the touch display displays the default user interface (step 260). The determination that mobile electronic device is not being handheld includes the situation where it cannot be determined if the device is being held by the left hand or the right hand.

Determination of one hand operation in the Step 230 refers to the processor 110 determining if the mobile electronic device 100 is being held by the left hand, the right hand, or not being held by hand. When the processor 110 determines that the mobile electronic device 100 is being held by the left hand, a touch display 130 displays a left hand user interface (Step 240). When the processor 110 determines that the mobile electronic device 100 is being held by the right hand, the touch display 130 displays a right hand user interface (Step 250). When the processor 110 determines that the mobile electronic device 100 is not being held by hand, the touch display 130 displays a default user interface (Step 260).

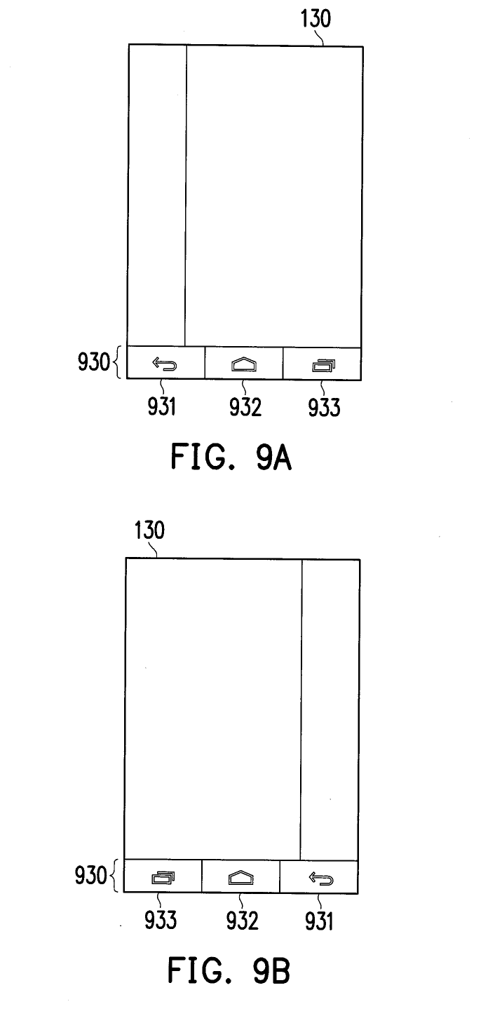

Examples of the left hand user interface include the interfaces shown in FIGS. 9A, 10A, 10B, 12, and 13A. A common feature of the interfaces is that the various common virtual buttons or application program icons are displayed along the left side of touch display 130. Examples of the right hand user interface include the interfaces shown in FIGS. 9B, 11A, 11B, 12, and 13B. A common feature of the interfaces is that the various common virtual buttons or application program icons are displayed along the right side of touch display 130.

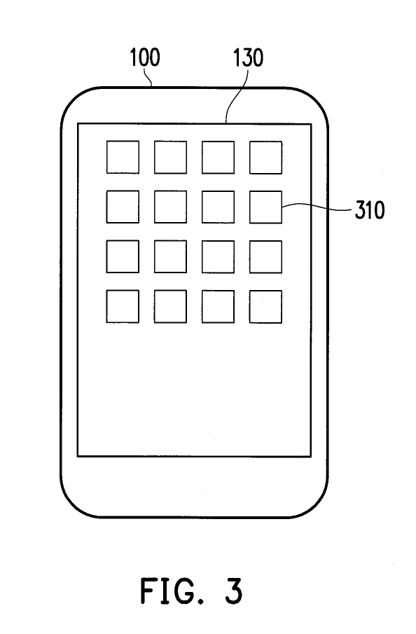

The default user interface in Step 260 is a centered user interface without tilting toward the left side or the right side. FIG. 3 is a diagram of a default user interface of an embodiment. The default user interface displayed by a touch display 130 of FIG. 3 includes a plurality of icons representing application programs, such as an icon 310, and the icons are evenly distributed in an array between the left side and the right side of the touch display 130. The user may hit one of the icons to execute the corresponding application program.

In another embodiment, the user can in accordance to his preference of one hand operation change the default user interface of the Step 260 to the left hand user interface in Step 240 or the right hand user interface in the Step 250.

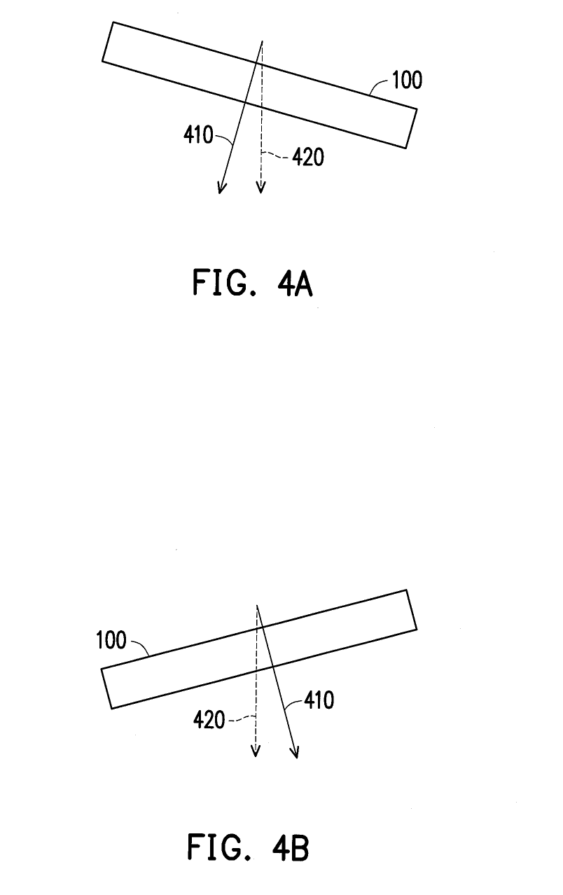

In the Step 230 determination of one hand operation, the Processor 110 can use one method or multiple methods. For example, FIGS. 4A to 4B are diagrams of a method for determination of one hand operation from an embodiment. FIGS. 4A and 4B shows the bottom of a side of the mobile electronic device 100. In this embodiment, a processor 110 can base on a detection value generated by a motion sensor 120 determine the position of a gravity direction 420 relative to a normal line 410 of the mobile electronic device 100, and base on the above detection value determine whether the mobile electronic device 100 is being held by the left hand or the right hand. When the detection value is within a first detection value range, it means the normal line 410 is on the left side of the gravity direction 420, as shown in FIG. 4A, then the processor 110 can determine the mobile electronic device 100 is being held by the left hand, and the touch display 130 displays the left hand user interface. When the detection value is within a second detection value range, it means the normal line 410 is on the right side to the gravity direction 420, as shown in FIG. 4B, then the processor 110 can determine the mobile electronic device 100 is being held by the left hand, and the touch display 130 displays the left hand user interface. When the detection value is not within the first or the second detection value range, it means the normal line 410 is not on the left or the right to the gravity direction 420, then the processor 110 can determine the mobile electronic device 100 is not being handheld, and the touch display 130 displays the default user interface. In this embodiment, the normal line 410 refers to a display side that is vertical to touch display 130 and faces the back of mobile electronic device 100. Additionally, the range of the first detection value and the range of the second detection value may be decided by experiments recording the detection values generated by the mobile electronic device 100 when a user operates the mobile electronic device 100 with the right hand, and when the user operates the mobile electronic device 100 with the left hand, and the range can be saved in mobile electronic device 100 in advance. Furthermore, each detection value range above refers to a range between two detection values. In this embodiment, the two detection values can be different values or the same value.

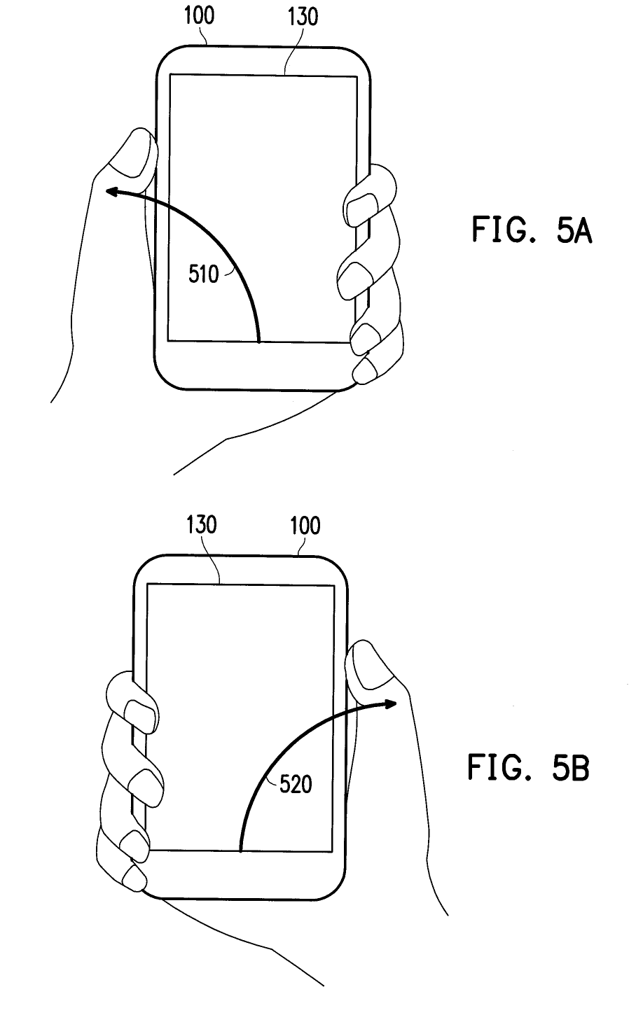

FIGS. 5A to 5B are diagrams of a method of determination of one hand operation from another embodiment. In this embodiment, the user can use a default operation, for example sliding one finger on a touch display 130, to wake up the mobile electronic device 100 from sleep mode. The touch display 130 can detect this default operation. A processor 110 can in response to the default operation cause the mobile electronic device 100 to enter work mode from sleep mode. When operating with one hand, usually the user uses the thumb to slide, so the processor 110 can analyze and determine the track of this operation. When the processor 110 determines the track is a counter-clockwise movement, for example track 510 of FIG. 5A, the processor 110 can determine that the mobile electronic device 100 is being held by the left hand. When the processor 110 determines the track is a clockwise movement, for example track 520 of FIG. 5B, the processor 110 can determine that the mobile electronic device 100 is being held by the right hand. When the processor 110 determines that the track is not a counter-clockwise movement or clockwise movement, for example using the index finger of the other hand to slide in linear motion on the touch display 130, then the processor 110 can determine the mobile electronic device 100 is not being operated with just one hand.

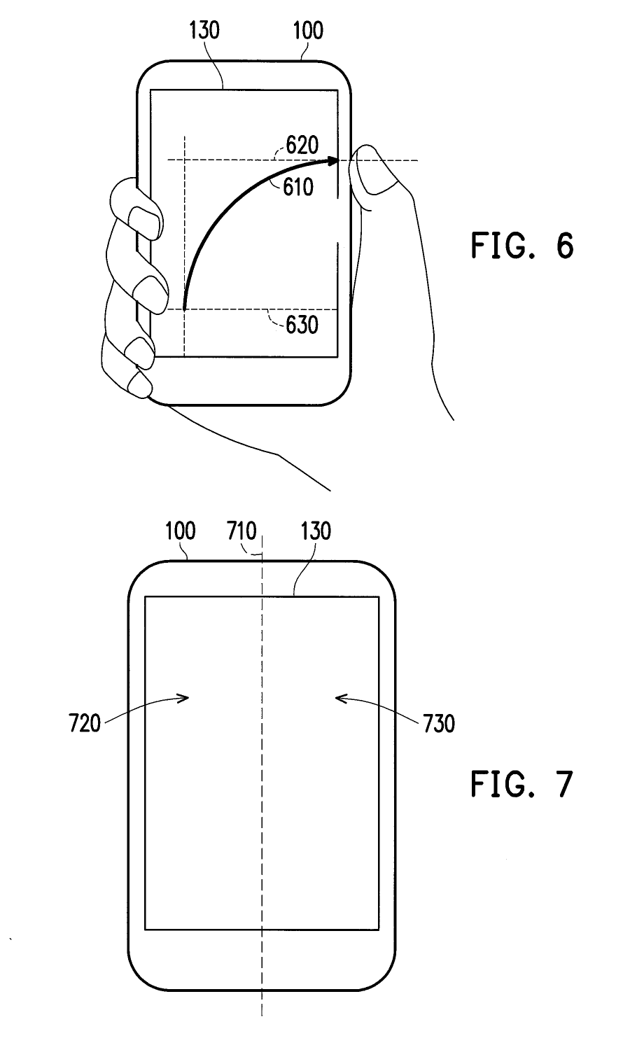

The above described track from the default operation can be used to confine the display area of the user interface in order to make user operation more convenient by confining the user interface to within the range that can be reached by the user's finger As shown by FIG. 6, 620 shows the top end position of a default operation track 610. And 630 shows the bottom end of the track 610. The processor 110 can record and save the top end position of track 610, namely, the position 620, and use it as the upper limit of the display area of the user interface. Also, the processor 110 can record and save the bottom end position of track 610, namely, the position 630, and use it as the lower limit of the display area of the user interface. Also, the processor 110 can record and save the top end position of track 610, the position 620, and the bottom end of the position of 610, the position 630, and use them as the upper limit and the lower limit, respectively, of the display area of the user interface.

When the user operates the mobile electronic device 100 through the touch display 130, contact with touch display 130 necessarily occurs. The processor 110 can analyze the multiple contact points within a preset time frame and, and based on whether the position of the contacts concentrate on the left side or the right side of the touch display 130, proceed to the one hand determination in step 230.

For example, FIG. 7 is a diagram of a method for determination of one hand operation from an embodiment of this invention. In this embodiment, a touch display 130 is divided into a left display area 720 and a right display area 730 by a line in the middle, line 710. The touch display 130 can detect multiple contact positions within a preset time frame. A processor 110 determines whether each contact position is within the display area 720 which is the left half of the display area, or within the display area 730 which is in the right half of the display area. When the number of contact positions in the display area 720 is greater than a first threshold value, the processor 110 can determine that the mobile electronic device 100 is being held by the left hand. When the number of contact positions in the display area 730 is greater than a second threshold value, the processor 110 can determine that the mobile electronic device 100 is being held by the left hand. When the number of contact positions in both the display area 720 and the display area 730 are less than a first threshold value, the processor 110 can determine that the mobile electronic device 100 is not being held by hand. It should be understood that the first threshold value and the second threshold value above may be the same value or different values.

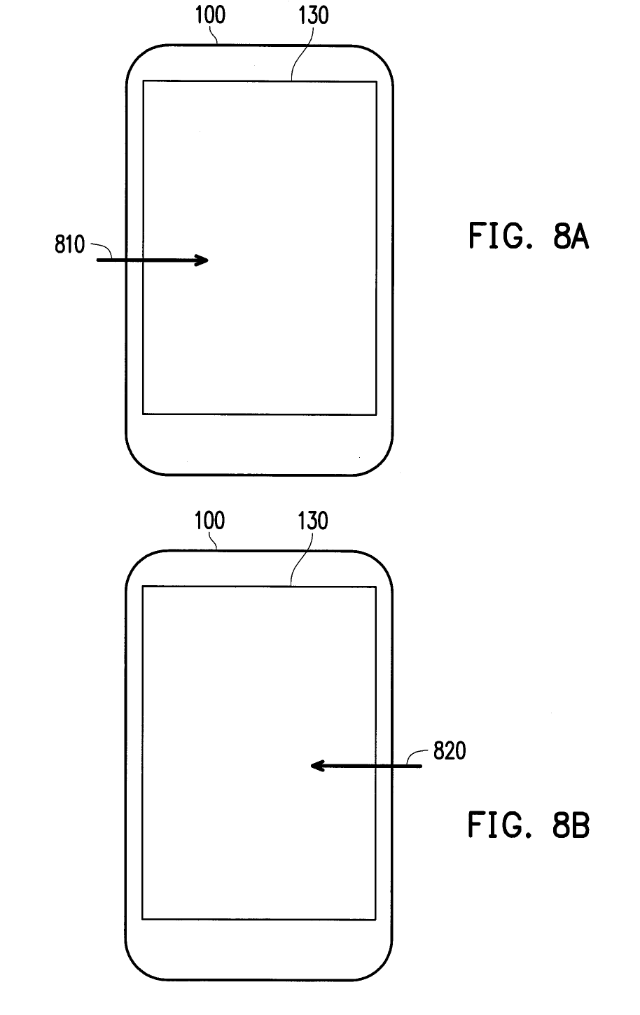

FIGS. 8A to 8B are diagrams of a method of determination of one hand operation from another embodiment. In this embodiment, the user can use default operation to actively declare whether the left hand or the right hand is being used for operation. For example, the above default operation may be using a finger to slide from the side of touch display 130 toward its center. The touch display 130 can detect this default operation. When the default operation occurs on the left side of the touch display 130, for example the default operation 810 in FIG. 8A, then the processor 110 can determine the mobile electronic device is being held by the left hand. When the default operation occurs on the right side of the touch display 130, for example the default operation 820 in FIG. 8B, then the processor 110 can determine the mobile electronic device is being held by the right hand. If the touch display does not detect this default operation, then the processor 110 can determine that the electronic mobile device is not being operated with just one hand.

The above embodiments provide a number of different methods for determination of one hand operation. The processor 110 can use one or more than one methods to use for the one hand determination in the step 230. Using fewer methods conserves power when using more methods increases the accuracy of determination. When only one method is used, then the resulting determination of the method is the determination of the Step 230. When more than one method are used, then determination result can be based on the resulting determinations of the methods.

In an embodiment, the processor 110 uses more than one method for determination of step 230 one hand determination. If the determination of each method is that the electronic mobile device 100 is being held by the left hand, then the result of the step 230 determination is that the electronic mobile device 100 is being held by the left hand. If the determination of each method is that the electronic mobile device 100 is being held by the right hand, then the result of the step 230 determination is that the electronic mobile device 100 is being held by the right hand. Otherwise the resulting determination is that the electronic mobile device 100 is not being held by just one hand.

In an embodiment, the processor 110 used more than one method for determination of step 230 one hand determination. The processor 110 executes the priority determination method. If the priority method's determination is that the electronic mobile device is being held by left hand or by the right hand, the processor 110 uses the determination of the priority method as the determination of the step 230. If the priority method's determination is that the electronic mobile device 100 is not being handheld, then the processor executes the second priority method. If the second priority method's determination is that the electronic mobile device is being held by left hand or by the right hand, the processor 110 uses the determination of the second priority method as the determination of the step 230. If the second priority method's determination is that the electronic mobile device 100 is not being handheld, then the processor executes the third priority method. And so on. If the processor 110 executes to the last method, then the determination of the last method is the determination of the step 230.

In an embodiment, an electronic mobile device 100 can execute the user display method in FIG. 2 when entering work mode for the first time or when entering into work mode from sleep mode. Before the electronic mobile device 100 leaves work mode, the user display method of FIG. 2 will not execute again, so the touch display 130 does not switch between the left hand user interface, the right hand user interface, and the default user interface. That is to say, the type of user interface is decided when entering into work mode, and it is possible to switch the user interface only when the electronic mobile device 100 enters work mode again.

In another embodiment, when the electronic mobile device 100 is already in work mode the motion sensor 120 can periodically execute the step 210, and the processor 110 can execute steps 220 and 230 periodically to determine whether the electronic mobile device 100 is being held by the left hand, by the right hand, or not being held by just one hand. The processor 110 can compare the current result described above to the previous result, also described above. When the current determination result is different from the determination result from the previous time, the touch display 130 can base on the current result described above and execute the steps 240, 250, or 260, in order to switch to the appropriate user interface. That is to say, the user interface of this embodiment can switch at any time without the need to wait for the next entrance into work mode.

The touch display 130 may include a control column on the lower side of the user interface. The control column may include a number of icons that can be operated to initiate the various functions of the mobile electronic device 100. The processor 110 may place the above icons in the control column in order of frequency of use or importance. For ease of operation by left hand, when the mobile electronic device 100 is being held by the left hand, the aforementioned icons may be arranged such that the frequently of use or importance of the icons increases from the right to the left, with the most frequently used or important icons placed on the left side. When the mobile electronic device 100 is being held by the right hand, the aforementioned icons may be arranged such that the frequently of use or importance of the icons increases from the left to the right, with the most frequently used or important icons placed on the right side. For example, FIGS. 9A and 9B are diagrams of a control column 930 of the user interface of an embodiment. The control column 930 includes three icons used to operate, icons 931˜933. FIG. 9A depicts the control column 930 when a mobile electronic device 100 is being held and operated by the left hand. FIG. 9B depicts the control column 930 when the mobile electronic device 100 is being held and operated by the right hand. The order of icons 931˜933 in FIGS. 9A and 9B are reversed. In this embodiment, icon 931 displays a [return to the previous page] function, icon 932 displays a [return to the main page] function, and icon 933 displays a [display applications that are executing] function.

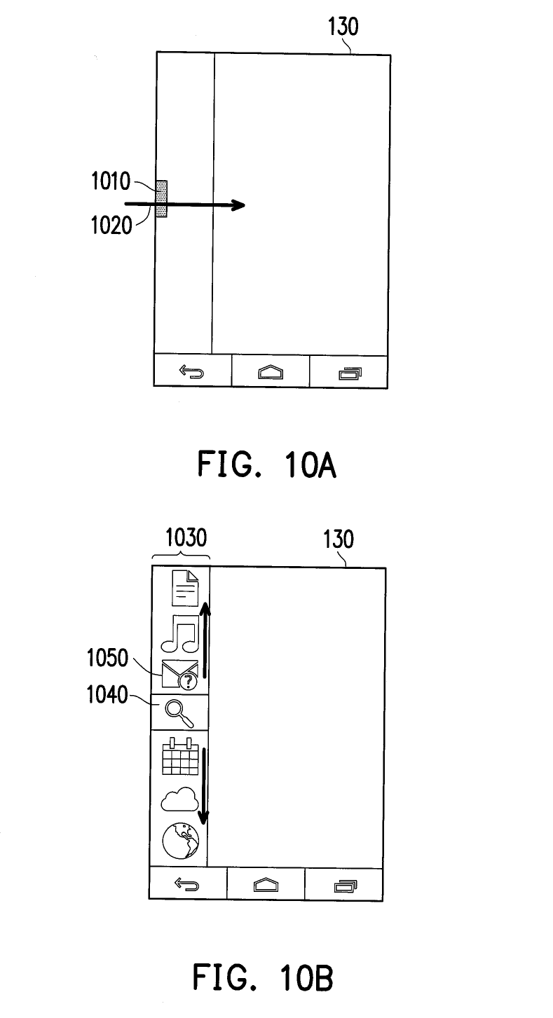

FIGS. 10A to 10B are diagrams of a program column 1030 of a left hand user interface of an embodiment of this invention. A small square 1010 in the user interface in FIG. 10A is an indication icon used to indicate that the user can use a default operation to bring out the programs column 1030 from area of the small square. A default operation 1020 of this embodiment is sliding a finger from the indication icon toward the middle on a touch display 130. When a mobile electronic device is being held and used by the left hand, the indication icon displays on the left side of the touch display 130. When a mobile electronic device is being held and used by the right hand, the indication icon displays on the right side of the touch display 130.

When the touch display 130 detects the default operation 1020 in the area of the indication icon, the touch display 130 brings out from the left side of the display 130 and displays the control column 1030. The program column 1030 includes a plurality of icons representing application programs, for example an icon 1050, displayed along the left side of the touch display 130. When any of the icons in the program column 1030 is touched, a processor 110 executes the application program that corresponds to the icon. In this embodiment, the user can, by dragging action, slide the program column 1030 up and down in order to look up application programs quickly.

The program column 1030 includes a search icon 1040. The search icon 1040 is displayed in the middle of the program column 1030, with the search icon 1040 having a plurality of adjacent application program icons on top of it and below it. The search icon 1040 can be used to search one or more application programs of the mobile electronic device 100. After the above search, the program column 1030 can display the icons of the application programs found for the user to select and use.

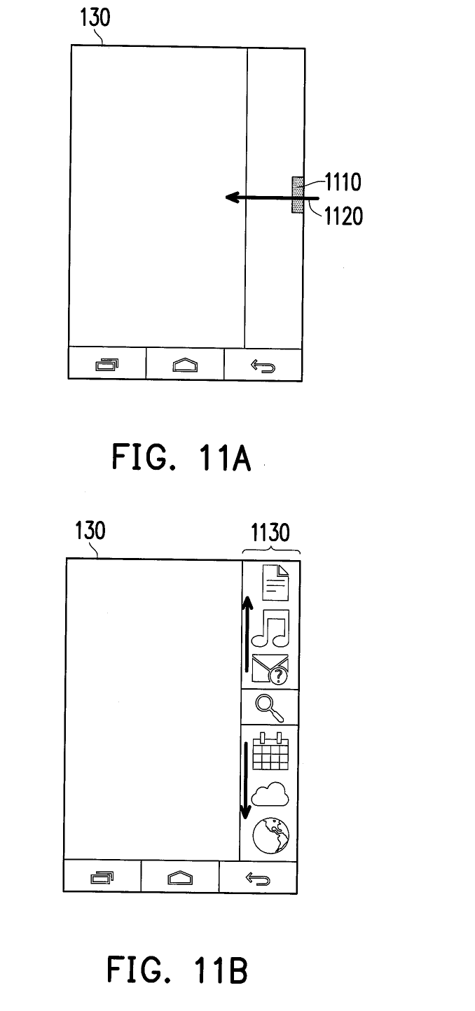

FIGS. 11A to 11B are diagrams of a program column 1130 of the right hand user interface of an embodiment. A small square 1110 in the user interface in FIG. 11A is an indication icon used to signify that the user can use a default operation to bring out the programs column 1130 from area of the small square. When the touch display 130 detects the default operation 1120 in the area of the indication icon, the touch display 130 brings out from the right side and displays and displays the control column 1130. The program column 1130 includes a plurality of icons representing application programs, for example an icon 1050, displayed along the right side of the touch display 130. The program column 1130 also includes the search icons described above. The difference between the right hand user interface of FIGS. 11A and 11B and the left hand user interface of FIGS. 10A and 10B is that they are in opposite positions. They are identical otherwise.

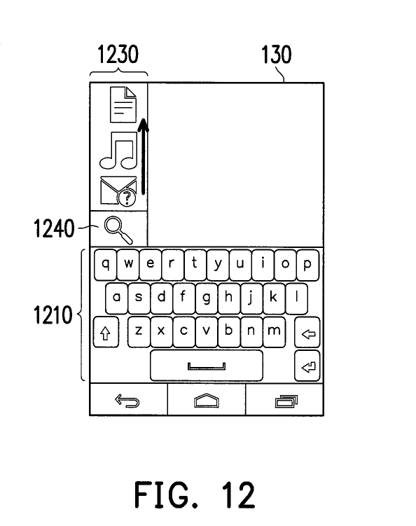

There are a number of embodiments for the search function for searching icons. FIG. 12 is a diagram showing the search function of the user interface of an embodiment. When a touch display 130 detects a default function directed to a search icon 1240, the touch display 130 displays a virtual keyboard 1210 in the user interface. The above described default operation can be touching the search icon 1240. The user can use the virtual keyboard 1210 to input the search criteria, and a processor 110 can search one or more application programs in the mobile electronic device 100 based on the search criteria received by the virtual keyboard 1210. For example, the above search criteria can be at least one English letter, and the application programs that fit the criteria are the application programs with names that begin with the English letter.

The application programs matching the search criteria described above will be displayed in the program column 1230 for the user to select and execute the application programs corresponding to the icons. The processor 110 can decide the order the application programs described above are displayed based on the degree of match between the search criteria and the application programs. For example, the degree of match can decrease as the distance between the icons and the search icon 1240 increases. In other words, the icons in the programs column 1230 begins from the search icon 1240 and extends up and down based on the degree of match. The closest to the search icon 1240 is the application program with the highest degree of match to the search criteria, and the farthest from the search icon 1240 is the application program with the lowest degree of match to the search criteria.

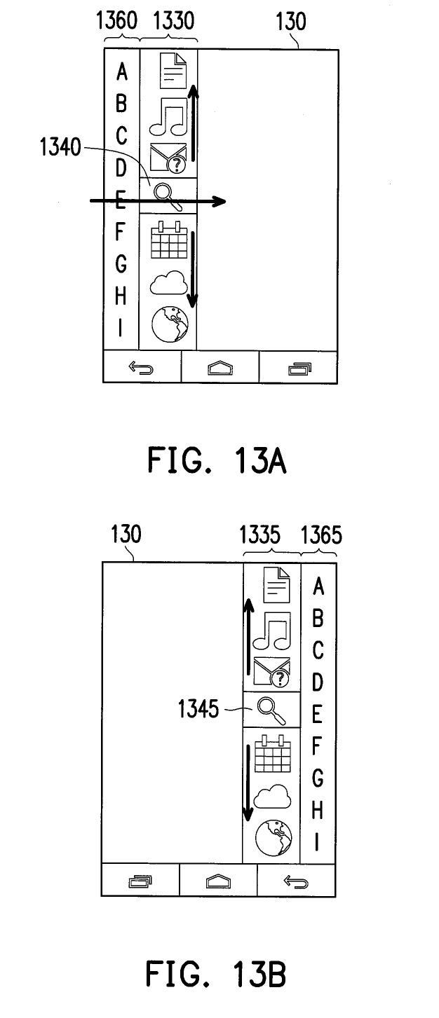

FIG. 13A is a diagram showing a search function of a left hand user interface of an embodiment. When a touch display 130 detects a default operation by a user, the touch display 130 displays a vertical characters column 1360 in the user interface. The characters column 1360 is directly adjacent to a programs column 1330. The default operation described above may be touching the search icon 1340 for a duration longer than a default duration T. The default operation described above may also be sliding a finger on the touch display 130 from a side of programs column 1330 towards the middle, as depicted in a default operation 1020 in FIG. 10A. As described above, when a mobile electronic device is being held by the left hand, the above described side is the left side. As described above, when a mobile electronic device is being held by the right hand, the above described side is the right side.

The characters column 1360 includes a plurality of characters. The characters column 1360 is near the thumb of the one hand the user uses to operate the mobile electronic device 100, and can be slid up and down by the thumb of the user, so the characters column 1360 is more suitable than the virtual keyboard 1210 is for one hand operation. The user can use the characters column 1360 to input search criteria, and the processor 110 can search the application programs based on the search criteria received by the characters column 1360. As described above, the processor 110 can decide the order the icons of the application programs described above are displayed in the programs column 1330 based on the degree of match between the search criteria and the application programs.

FIG. 13B is a diagram showing a search function of a right hand user interface of an embodiment. The right hand user interface of this embodiment includes a programs column 1335 and a characters column 1365. The programs column 1335 includes a search icon 1345. The difference between the right hand user interface of FIG. 13B and the left hand user interface of FIG. 13A is that they are in opposite positions. They are otherwise identical.

A track 610 of default operation in FIG. 6 can also be used to confine the display area of the programs column and the characters column of the above embodiments. The processor 110 can record and save the top end position of track 610, the position 620, and use it as the upper limit of the display area of the programs column and the characters column. Or the processor 110 can record and save the bottom end position of track 610, the position 630, and use it as the lower limit of the display area of the programs column and the characters column. Or, the processor 110 can record and save the top end position of track 610, the position 620, and the bottom end of the position of 610, the position 630, and use them as the upper limit and the lower limit, respectively, of the display area of the user interface.

The search icons in the above embodiments can also be used to initiate a voice search function by touching the search icon. When a touch display 130 detects a default function directed to a search icon, a microphone 140 can receive voice in response to this operation. The default operation described above may be by touching the search icon for a greater duration than a default duration T2. The duration of the default duration T2 can be longer than the above described default duration T1. For example, the content of the voice can be the name of the application program. The search icon 110 can be used to search one or more application programs of the mobile electronic device 100 based on the result of voice recognition. The above described voice can be considered as a search criterion. As described above, the processor 110 can decide the order the icons of the application programs described above are displayed in the programs column based on the degree of match between the search criteria and the application programs.

In an embodiment, the mobile electronic device 100 does not have voice activation function or voice search function. In this embodiment, the microphone 140 is optional.

This invention also provides a computer-readable recording medium. In an embodiment, a computer program is stored in the recording medium. When a mobile electronic device loads and executes the computer program, the mobile electronic device performs and completes the user interface display method in FIG. 2. The above described recording medium may be a floppy disk, a hard disk, an optical disc, or other types of physical non-transitory recording medium.

As described above, this invention provides an intelligent detection and calculation mechanism, allowing a mobile electronic device to switch back and forth between a left hand user interface, a right hand user interface, and a default user interface, based on various determination methods and factors such as how the user holds the mobile electronic device, touch control operation, preference settings and the operation habits, etc. As such, this invention achieves the goal of easy and friendly one hand operation, making the ever enlarging displays of mobile electronic device more convenient to use. Also, this invention can place the most important or the most frequently used application programs or interface in the areas that are the easiest to reach and operate from, in order to improve the user experience.

Although the disclosure has been described with reference to the above embodiments, it will be apparent to one of the ordinary skill in the art that modifications to the described embodiments may be made without departing from the spirit of the disclosure. Accordingly, the scope of the disclosure is defined by the attached claims not by the above detailed descriptions.

What is claimed is:

1. A mobile electronic device, operable in a sleep mode or a work mode, comprising:
a motion sensor, detecting a motion of the mobile electronic device and accordingly generating a detection value;
a processor, coupled to the motion sensor, wherein when the mobile electronic device is in the work mode, the processor determines whether the detection value is within a first detection value range or a second detection value range; and
a touch display, coupled to the processor, displaying a first user interface when the detection value is determined by the processor to be within the first detection value range, and displaying a second interface when the detection value is determined by the processor to be within the second detection value range, and displaying a third user interface when the detection value is determined by the processor to be not within the first detection value range or the second detection value range, wherein the first user interface has a plurality of application program icons displayed along a first side of the touch display, the second user interface has the plurality of application program icons displayed along a second side of the touch display, the third user interface has the plurality of application program icons displayed evenly between the first side of the touch display and the second side of the touch display.

2. The mobile electronic device of claim 1, wherein the touch display detects a default operation, when the processor determines that the detection value is within the first detection value range and determines that a track of the default operation is moving counter-clockwise, the touch display displays the first user interface, and when the processor determines that the detection value is within the second detection value range and determines that a track of the default operation is moving clockwise, the touch display displays the second user interface.

3. The mobile electronic device of claim 2, wherein the processor records a top end position of the track and the top end position is an upper limit of display areas of the first and the second user interfaces.

4. The mobile electronic device of claim 2, wherein the processor records a bottom end position of the track and the bottom end position is a lower limit of display areas of the first and the second user interfaces.

5. The mobile electronic device of claim 1, wherein the touch display detects a plurality of contact positions, the processor determines whether each of the contact positions is within a first display area or a second display area; when the processor determines the detection value is within the first detection value range and determines a number of the contact positions within the first display area exceeds a first threshold value, the touch display displays the first user interface, and when the processor determines the detection value is within the second detection value range and determines a number of the contact positions within the second display area exceeds a second threshold value, the touch display displays the second user interface.

6. The mobile electronic device of claim 1, wherein each of the first and the second user interfaces includes a control column, and the control column comprises a plurality of icons that can be operated, and the processor places the icons in order of frequency of use or importance; when the touch display displays the first user interface, the frequently of use or importance of the icons increases from the second side to the first side; when the touch display displays the second user interface, the frequency of use or importance of the icons increases from the first side to the second side.

7. The mobile electronic device of claim 1, wherein when the processor determines the detection value is within the first detection value range and the touch display detects a first default operation on the first side, the touch display displays the plurality of application program icons along the first side, and when the processor determines the detection value is within the second detection value range and the touch display detects the first default operation on the second side, the touch display displays the plurality of application program icons along the second side.

8. The mobile electronic device of claim 7, wherein the plurality of application programs icons are arranged in a programs column and includes a search icon used to search at least one application program of the plurality of application programs; when the touch display detects a second default operation directed to the search icon, the touch display displays a virtual keyboard; the processor searches the at least one application program based on a search criterion received by the virtual keyboard.

9. The mobile electronic device of claim 7, wherein the plurality of application programs icons are arranged in a programs column and comprises a search icon used to search at least one application program of the plurality of application programs; when the touch display detects a second default operation, the touch display displays a characters column, the characters column is directly adjacent to the programs column; the processor search the at least one application program based on a search criterion received by the characters column.

10. The mobile electronic device of claim 1, wherein when the mobile electronic device enters into the work mode for the first time or enters from the sleep mode into the work mode, the processor determines whether the detection value is within the first detection value range or the second detection value range.

11. The mobile electronic device of claim 10, wherein and the processor determines periodically whether the detection value is within the first detection value range or within the second detection value range in the work mode.

12. A user interface display method, used in a mobile electronic device operable in a sleep mode or in a work mode and comprising a touch display, the method comprising:
detecting a motion of the mobile electronic device and accordingly generating a detection value;
determining whether the detection value is within a first detection value range or a second detection value range;
displaying a first user interface on the touch display when the detection value is determined to be within the first detection value range, wherein the first user interface includes a plurality of application program icons displayed along a first side of the touch display;
displaying a second user interface on the touch display when the detection value is determined to be within the second detection value range, wherein the second user interface includes the plurality of application programs displayed along a second side of the touch display; and
displaying a third user interface on the touch display when the detection value is determined to be not within the first or the second detection value range, wherein the third user interface includes the plurality of application programs displayed evenly between the first and the second sides of the touch display.

13. The user interface display method of claim 12, further comprising:
detecting a default operation;
switching the mobile electronic device from the sleep mode into the work mode in response to the default operation;
analyzing a track of the default operation;
displaying the first user interface on the touch display when the detection value is determined to be within the first detection value range and the track moves counter-clockwise; and
displaying the second user interface on the touch display when the detection value is determined to be within the second detection value range and the track moves clockwise.

14. The user interface display method of claim 13, further comprising:
recording a top end position of the track and the top end position is an upper limit of display areas of the first and the second user interfaces.

15. The user interface display method of claim 12, further comprising:
detecting the plurality of contact positions on the touch display;
determining whether each of the contact positions is within a first display area or a second display area of the touch display;
displaying the first user interface on the touch display when the detection value is determined to be within the first detection value range and a number of the contact positions in the first display area is greater than a first threshold value; and
displaying the second user interface on the touch display when the detection value is determined to be within the second detection value range and a number of the contact positions in the second display area is greater than a second threshold value.

16. The mobile electronic device of claim 12, wherein each of the first and the second user interfaces includes a control column, the control column includes a plurality of icons that can be operated, and when the first user interface is displayed, a frequency of use or importance of the plurality of icons increases from the second side to the first side; when the second user interface is displayed, the frequency of use or importance of the plurality of icons increases from the first side to the second side.

17. The user interface display method of claim 12, further comprising:
displaying the plurality of application program icons along the first side of the touch display when the detection value is determined to be within the first detection value range and the touch display detects a first default operation on the first side; and
displaying the plurality of application program icons along the second side of the touch display when the detection value is determined to be within the second detection value range and the touch display detects the first default operation on the second side.

18. The user display method of claim 17, wherein the plurality of application program icons are arranged in a programs column and includes a search icon used to search at least one application program of the plurality of application programs, the method further comprises:
displaying a virtual keyboard on the touch display when a second default operation directed to the search icon is detected; and
searching the at least one application program based on a search criterion received by the virtual keyboard.

19. The user display method of claim 17, wherein the plurality of application program icons are arranged in a programs column and comprises a search icon used to search at least one application program of the plurality of application programs, and the method further comprises:
displaying a characters column on the touch display when the touch display detects a second default operation, wherein the characters column is directly adjacent to the programs column; and
searching the at least one application program based on a search criterion received by the characters column.

20. A computer-readable recording medium, storing a computer program, wherein when a mobile electronic device loads and executes the computer program, the mobile electronic device performs the user interface display method of claim 12.
